(19) United States
(12) Patent Application Publication
(10) Pub. No.: US 2024/0271335 A1
(43) Pub. Date: Aug. 15, 2024

(54) CARBON SEQUESTRATION SYSTEM AND PROCESS AND PYROLYSIS PROCESS AND REACTOR

(71) Applicants: SOCPRA SCIENCES ET GENIE S.E.C., Sherbrooke (CA); KWI KUNSTSTOFFWERK INDUSTRIES INC., Montreal (CA)

(72) Inventors: Nicolas ABATZOGLOU, Laval (CA); François GITZHOFER, Sherbrooke (CA); Yves LAROCHE, Boisbriand (CA); Jasmin BLANCHARD, Sherbrooke (CA)

(21) Appl. No.: 18/567,812

(22) PCT Filed: Jun. 17, 2022
(86) PCT No.: PCT/CA2022/050977

§ 371 Date: Dec. 7, 2023

Related U.S. Application Data
(60) Provisional application No. 63/211,760, filed on Jun. 17, 2021.

(51) Int. Cl. D01F 9/127; B01J 21/04; B01J 23/755; B01J 35/30; B01J 35/40; C10B 49/10; C10B 53/07; D01F 9/133

(52) U.S. Cl. CPC D01F 9/1272; B01J 21/04; B01J 23/755; B01J 35/394; B01J 35/40; D01F 9/133; C10B 49/10; C10B 53/07

(57) ABSTRACT

There is provided a process for continuously producing carbon nanofilaments and a carbon sequestration reactor for continuously producing carbon nanofilaments. There is also provided a pyrolysis system configured to produce a pyrolysis product including fuel from a carbon-based feedstock, such waste plastics. There is also provided a pyrolysis process wherein at least a portion of the pyrolysis product is recycled as fuel for the pyrolysis system and/or as feedstock for the carbon sequestration process and reactor. At least a portion of the products of the carbon sequestration process and reactor can be fed into a plasma reactor to produce hydrogen and carbon black and/or graphene.

### CROSS-REFERENCE TO RELATED APPLICATIONS

The present application is a national stage application of International Application No. PCT/CA2022/050977, filed on Jun. 17, 2022, which claims priority under 35USC§ 119(e) of U.S. provisional patent application 63/211,760 filed Jun. 17, 2021, the entire contents of each of which are hereby incorporated by reference herein in their entirety.

### TECHNICAL FIELD

The technical field relates to a carbon sequestration process and a pyrolysis system which can be combined to convert a carbon-based feedstock into energy and other valuable products. It also to relates to a process for pyrolysing a carbon-based feedstock, a process sequestering carbon from hydrocarbon compounds, which can originate from plastic waste pyrolysis, to produce carbon nanofilaments and a reactor for carbon nanofilament production.

### BACKGROUND

Plastic waste production and consumption are increasing at an alarming rate. Furthermore, a major portion of plastics produced each year is used to make disposable items of packaging or other short-lived products that are discarded within a year of manufacture. Managing waste plastics is thus a challenge in order to reduce the discarded end-of-life plastics accumulating as debris in landfills and in natural habitats worldwide.

Pyrolysis is a common technique used to convert plastic waste into energy, in the form of solid, liquid and gaseous fuels, and other valuable products. However, plastic pyrolysis is an endothermic and high energy consuming process. It requires at least 350-500° C. and temperatures as high as 700-900° C. may be needed for achieving better product yields.

Since pyrolysis is an interesting solid waste management technology to convert waste plastics to fuel, there is a need to reduce its ecological footprint by optimizing its energy consumption. In view of the above, there is a need for a pyrolysis system and process which would be able to overcome or at least minimize some of the above-discussed prior art concerns.

In addition, the plastics pyrolysis products have a relatively high carbon content that could be sequestered to reduce the carbon footprint. Carbon can be sequestered by producing carbon nanofilaments (CNFs) in a carbon sequestration reactor. Existing carbon sequestration reactors are semi-batch reactors which must be stopped at intervals to remove the CNFs. In view of the above, there is a need for a carbon sequestration reactor which would be able to overcome or at least minimize some of the above-discussed prior art concerns.

### BRIEF SUMMARY OF THE INVENTION

It is therefore an aim of the present invention to address the above-mentioned issues.

According to a general aspect, there is provided a process for producing carbon nanofilaments. The process comprises: feeding a reaction chamber containing carbon-sequestration catalyst particles with a continuous gaseous flow containing hydrocarbon compounds and carbon oxide through a gas inlet; inside the reaction chamber, introducing at least partially the gaseous flow into a first gas conduit mounted above the gas inlet and vertically spaced-apart therefrom, the first gas conduit being opened at both ends; and withdrawing gas from the reaction chamber through a gas outlet located above a bed of the catalyst particles contained in the reaction chamber; whereby, during operation, the catalyst particles are siphoned up and fluidized by the gaseous flow and travel up to the first gas conduit through a space defined between the first gas conduit and the gas inlet and through the first end of the first gas conduit, exits at the top end of the first gas conduit, and fall outside the first gas conduit to be recirculated.

In an embodiment, the process further comprises preventing the catalyst particles from flowing into the gas inlet.

In an embodiment, the carbon oxide comprises carbon dioxide. A C/CO₂ in the continuous gas flow fed to the reaction chamber can be between about 0.5 and 2 and, in another embodiment, between about 0.8 and 1.2.

In an embodiment, the gaseous mixture is fed to the reaction chamber through a tapered portion thereof having a funnel shape and the catalyst particles fall outside the first gas conduit and towards the tapered portion of the reaction chamber to be recirculated.

In an embodiment, a gaseous mixture of the gaseous flow fed to the reaction chamber has a temperature above 400° C.

In an embodiment, a gaseous mixture of the gaseous flow contained inside the reaction chamber has a temperature between about 550° C. and about 700° C.

In an embodiment, the gas withdrawn from the reaction chamber comprises carbon nanofilaments, hydrocarbon compounds, and at least one of carbon monoxide, carbon dioxide, hydrogen, and water vapor. In an embodiment, the process further comprises filtering the gas withdrawn from the reaction chamber to recover the carbon nanofilaments from the gas. In an embodiment, the process further comprises dehumidifying the filtered gas.

In an embodiment, the gas are withdrawn continuously from the reaction chamber.

In an embodiment, the catalyst particles are iron-based and comprises at least 50% mol. of iron. The iron-based catalyst particles can further comprise nickel.

In an embodiment, the catalyst particles comprise Fe/Al₂O₃ including at least 10 wt % of iron within the catalyst particles.

In an embodiment, the catalyst particles are smaller than about 500 μm and, in a particular embodiment, the catalyst particles have a diameter between about 150 μm and about 500 μm.

In an embodiment, the process further comprises heating liquid hydrocarbon compounds to a gaseous state before feeding the reaction chamber with the continuous gaseous flow containing the hydrocarbon compounds.

In an embodiment, the gaseous flow has a mean contact time between about 1 second and about 10 seconds in the reaction chamber.

In an embodiment, a pressure drop across the bed of the catalyst particles ranges between about 0.5 atm to about 4 atm.

According to another general aspect, there is provided carbon nanofilaments produced by the process as described above.

According to still another general aspect, there is provided a process for producing carbon nanofilaments. The process comprises: continuously feeding a pyrolysis reactor with a carbon-based feedstock; pyrolyzing the carbon-based feedstock to generate a pyrolysis product; withdrawing the pyrolysis product from the pyrolysis reactor; continuously feeding a carbon sequestration reactor with at least a portion of the pyrolysis product, the carbon sequestration reactor containing a carbon sequestration catalyst to form carbon nanofilaments; and withdrawing a carbon sequestration reactor product including the carbon nanofilaments from the carbon sequestration reactor.

In an embodiment, withdrawing the carbon sequestration reactor product from the carbon sequestration reactor comprises continuously withdrawing the carbon sequestration reactor product from the carbon sequestration reactor, which can be carried out concurrently with withdrawing a continuous gas flow containing the carbon nanofilaments. The continuous gas flow withdrawn from the carbon sequestration reactor can comprise hydrocarbon compounds, and at least one of carbon monoxide, carbon dioxide, hydrogen, and water vapor. In an embodiment, the process further comprises filtering the continuous gas flow withdrawn from the carbon sequestration reactor to recover the carbon nanofilaments.

In an embodiment, the process further comprises continuously feeding an oxidation chamber of the pyrolysis reactor with an oxidizing agent and a fuel and at least partially oxidating the fuel in the oxidation chamber of the pyrolysis reactor to supply heat to a pyrolysis reaction chamber of the pyrolysis reactor. In an embodiment, the process further comprises recycling at least a portion of the pyrolysis product as fuel fed to the oxidation chamber. In an embodiment, the process further comprises separating the pyrolysis product into a gas product and a liquid product and wherein the fuel comprises at least a portion of the gas product obtained from the separation of the pyrolysis product. In an embodiment, the process further comprises condensing at least a portion of the pyrolysis product withdrawn from the pyrolysis reaction chamber and increasing a pressure of a portion of the pyrolysis product following condensation and before recycling the at least a portion of the pyrolysis product as the fuel fed to the oxidation chamber.

The oxidation chamber can be fed continuously with the oxidizing agent and the fuel and/or the pyrolysis reaction chamber can be fed continuously with the carbon-based feedstock. The oxidizing agent can comprise at least one of air and oxygen. The fuel and the oxidation agent can be fed into the oxidation chamber in a ratio ranging between about 0.5 and about 1.1 and, in a particular embodiment, in a ratio ranging between about 0.9 and about 1.1. The pyrolysis of the carbon-based feedstock can be carried out at a temperature ranging between about 550° C. and about 900° C. and, in a particular embodiment, at a temperature ranging between about 600° C. and about 850° C. The carbon-based feedstock can have a mean residence time between about 5 seconds and about 10 seconds in a pyrolysis reaction chamber of the pyrolysis reactor.

In an embodiment, withdrawing the pyrolysis product is carried out continuously.

In an embodiment, the carbon-based feedstock is a plastic-based feedstock and, more particularly, the plastic-based feedstock can be substantially chlorine-free. It can comprise plastic particles having a diameter smaller than about 1.5 cm and, in a particular embodiment, between about 0.1 cm and 1.3 cm.

In an embodiment, the pyrolysis of the carbon-based feedstock is performed in a pyrolysis chamber of the pyrolysis reactor containing a fluidized particle bed. The fluidized particle bed can comprise inert inorganic particles and/or thermo-catalytic particles selected from the group consisting of: dolomite or Ni—Al-spinel bearing particles.

In an embodiment, feeding the carbon sequestration reactor comprises feeding a reaction chamber of the carbon sequestration reactor through a gas inlet located in a tapered portion of the reaction chamber.

In an embodiment, the at least a portion of the pyrolysis product fed to the carbon sequestration reactor comprises hydrocarbon compound and carbon oxides having a C/CO₂ ratio between about 0.5 and about 2.

In an embodiment, the at least a portion of the pyrolysis product fed to the carbon sequestration reactor has a temperature above 400° C.

In an embodiment, the carbon sequestration catalyst comprises iron-based catalyst particles smaller than about 500 μm and comprises at least 50% mol. of iron. The iron-based catalyst particles can further comprise nickel.

In an embodiment, feeding the carbon sequestration reactor comprises feeding the carbon sequestration reactor with the at least a portion of the pyrolysis product in a gaseous state. In an embodiment, the process further comprises converting the at least a portion of the pyrolysis product to a gaseous state before feeding the carbon sequestration reactor.

According to a general aspect, there is provided carbon nanofilaments produced by the process as described above.

According to a further general aspect, there is provided a process for producing carbon nanofilaments. The process comprises: feeding a pyrolysis reactor with a carbon-based feedstock; pyrolyzing the carbon-based feedstock to generate a pyrolysis product; withdrawing the pyrolysis product from the pyrolysis reactor; feeding a carbon sequestration reactor with at least a portion of the pyrolysis product, the carbon sequestration reactor containing a carbon sequestration catalyst to form carbon nanofilaments and a gaseous product; withdrawing the carbon nanofilaments from the carbon sequestration reactor; feeding a plasma reactor with at least a portion of the gaseous product of the carbon sequestration reactor to produce a plasma reactor product comprising a gaseous product including hydrogen and at least one of carbon black and graphene; and feeding the pyrolysis reactor with at least a portion of the gaseous product from the carbon sequestration reactor.

In an embodiment, feeding the pyrolysis reactor with the carbon-based feedstock and at least a portion of the gaseous product from the plasma reactor comprises continuously feeding the pyrolysis reactor with the carbon-based feedstock and the at least a portion of the gaseous product from the plasma reactor; and withdrawing the pyrolysis product from the pyrolysis reactor comprises continuously withdrawing the pyrolysis product from the pyrolysis reactor.

In an embodiment, feeding the carbon sequestration reactor with at least the portion of the pyrolysis product comprises continuously feeding the carbon sequestration reactor with at least the portion of the pyrolysis product; and withdrawing the carbon nanofilaments from the carbon sequestration reactor comprises continuously withdrawing the carbon nanofilaments from the carbon sequestration reactor, which can be carried out concurrently with withdrawing a continuous gas flow containing the carbon nanofilaments.

In an embodiment, feeding the plasma reactor with the at least a portion of the gaseous product of the carbon sequestration reactor comprises continuously feeding the plasma reactor with the at least a portion of the gaseous product of the carbon sequestration reactor. The continuous gas flow withdrawn from the carbon sequestration reactor can comprise hydrocarbon compounds, and at least one of carbon monoxide, carbon dioxide, hydrogen, and water vapor. In an embodiment, the process further comprises filtering the continuous gas flow withdrawn from the carbon sequestration reactor to recover the carbon nanofilaments.

In an embodiment, the process further comprises continuously feeding an oxidation chamber of the pyrolysis reactor with an oxidizing agent to at least partially oxidating the at least a portion of the gaseous product from the plasma reactor in the oxidation chamber of the pyrolysis reactor to supply heat to a pyrolysis reaction chamber of the pyrolysis reactor. In an embodiment, the process further comprises recycling at least a gaseous portion of the pyrolysis product into the oxidation chamber of the pyrolysis reactor. Feeding the pyrolysis reactor with the carbon-based feedstock can comprise feeding the carbon-based feedstock into the pyrolysis reaction chamber of the pyrolysis reactor. The at least a portion of the gaseous product from the plasma reactor and the oxidation agent can be fed into the oxidation chamber in a ratio ranging between about 0.5 and about 1.1 and, in a particular embodiment, in a ratio ranging between about 0.9 and about 1.1.

In an embodiment, the pyrolysis of the carbon-based feedstock is carried out at a temperature ranging between about 550° C. and about 900° C. and, in a particular embodiment, at a temperature ranging between about 600° C. and about 850° C.

In an embodiment, the carbon-based feedstock has a mean residence time between about 5 seconds and about 10 seconds in a pyrolysis reaction chamber of the pyrolysis reactor.

In an embodiment, the carbon-based feedstock is a plastic-based feedstock and, more particularly, the plastic-based feedstock can be substantially chlorine-free. It can comprise plastic particles having a diameter smaller than about 1.5 cm and, in a particular embodiment, between about 0.1 cm and 1.3 cm.

In an embodiment, the pyrolysis of the carbon-based feedstock is performed in a pyrolysis chamber of the pyrolysis reactor containing a fluidized particle bed. The fluidized particle bed can comprise inert inorganic particles and/or thermo-catalytic particles selected from the group consisting of: dolomite or Ni—Al-spinel bearing particles.

In an embodiment, feeding the carbon sequestration reactor comprises feeding a reaction chamber of the carbon sequestration reactor through a gas inlet located in a tapered portion of the reaction chamber.

In an embodiment, the at least a portion of the pyrolysis product fed to the carbon sequestration reactor comprises hydrocarbon compound and carbon oxides having a C/CO₂ ratio between about 0.5 and about 2.

In an embodiment, the at least a portion of the pyrolysis product fed to the carbon sequestration reactor has a temperature above 400° C.

In an embodiment, the carbon sequestration catalyst comprises iron-based catalyst particles smaller than about 500 μm and comprises at least 50% mol. of iron. The iron-based catalyst particles can further comprise nickel.

In an embodiment, feeding the carbon sequestration reactor comprises feeding the carbon sequestration reactor with the at least a portion of the pyrolysis product in a gaseous state.

In an embodiment, the process further comprises filtering the pyrolysis product to at least partially remove solid particles before feeding the carbon sequestration reactor with the at least a portion of the pyrolysis product.

In an embodiment, the gaseous product of the carbon sequestration reactor comprises water, hydrogen and carbon monoxide and the process further comprises at least partially removing the water, the hydrogen and the carbon monoxide from the gaseous product of the carbon sequestration reactor before feeding the plasma reactor with the at least a portion of the gaseous product of the carbon sequestration reactor. In an embodiment, the process further comprises feeding the pyrolysis reactor with at least a portion of the carbon monoxide recovered from the gaseous product of the carbon sequestration reactor. In an embodiment, the process further comprises feeding the pyrolysis reactor with at least a portion of the hydrogen recovered from the gaseous product of the carbon sequestration reactor.

In an embodiment, the process further comprises separating the at least one of carbon black and graphene and the gaseous product of the plasma reactor product, which can be performed by filtration of the plasma reactor product. In an embodiment, the process further comprises recycling at least a portion of the gaseous product of the plasma reactor product to feed the carbon sequestration reactor. The gaseous product of the plasma reactor product can comprise hydrogen and light hydrocarbons.

According to a general aspect, there is provided carbon nanofilaments, graphene and/or carbon black produced by the process as described above.

According to another general aspect, there is provided a carbon sequestration reactor for producing carbon nanofilaments comprising: a housing and a carbon sequestration unit. The housing defines a reaction chamber with a tapered portion and containing catalyst particles. The housing has a gas inlet and a gas outlet defined therein, the gas inlet being opened in the tapered portion of the reaction chamber and the gas outlet being located above a bed of the catalyst particles contained in the reaction chamber. The carbon sequestration unit is located inside the reaction chamber and comprises a first gas conduit mounted above the gas inlet and vertically spaced-apart therefrom, the first gas conduit being opened at both ends.

In an embodiment, the first gas conduit is co-axial with the gas inlet. The first gas conduit can be in register with the gas inlet.

In an embodiment, the carbon sequestration reactor further comprises a second gas conduit extending in the reaction chamber and having a first end mounted to the housing and circumscribing the gas inlet and a second end spaced-apart from a first end of the first gas conduit and co-axial therewith. The first end of the first gas conduit and the second end of the second gas conduit can be in register.

In an embodiment, the carbon sequestration reactor further comprises a grid covering the gas inlet to prevent carbon-sequestration catalyst particles to flow outwardly of the reaction chamber through the gas inlet.

In an embodiment, the carbon sequestration reactor further comprises a bed of carbon-sequestration catalyst particles, which can be iron-based and can comprise at least 50% mol. of iron. In an embodiment, the iron-based catalyst particles can further comprise nickel. In an embodiment, the catalyst particles comprise Fe/Al₂O₃ including at least 10 wt % of iron within the catalyst particles.

In an embodiment, the catalyst particles are smaller than about 500 μm and, in a particular embodiment, they have a diameter between about 150 μm and about 500 μm.

In an embodiment, the carbon sequestration reactor further comprises a carbon dioxide supply in fluid communication with the gas inlet.

According to another general aspect, there is provided a pyrolysis system comprising a pyrolysis reactor. The pyrolysis reactor includes a housing defining a pyrolysis reaction chamber and an oxidation chamber separated from the pyrolysis reaction chamber through a partition grid and located below the pyrolysis reaction chamber. The housing has a carbon-based feedstock inlet opened in the pyrolysis reaction chamber, a pyrolysis product outlet opened in the pyrolysis reaction chamber, and a fuel inlet in gas communication with the oxidation chamber. The pyrolysis product outlet is in fluid communication with the fuel inlet of the pyrolysis reactor to direct at least partially a pyrolysis product into the oxidation chamber of the pyrolysis reactor.

In an embodiment, the pyrolysis system further comprises a phase separation unit connected to the pyrolysis product outlet and separating the pyrolysis product into a gaseous fuel and a liquid product, wherein the pyrolysis product outlet is in fluid communication with the fuel inlet of the pyrolysis reactor at least via the phase separation unit to direct at least partially the gaseous fuel into the oxidation chamber of the pyrolysis reactor.

In an embodiment, the fuel inlet is in gas communication with a gaseous fuel supply and an oxidizing agent supply, which can comprise at least one of an air supply and an oxygen supply.

In an embodiment, the pyrolysis system further comprises a pyrolysis product recirculation conduit in fluid communication with the pyrolysis product outlet and the fuel inlet and a mixer mounted to the pyrolysis product recirculation conduit, upstream of the fuel inlet and downstream of the oxidizing agent supply and in gas communication therewith.

In an embodiment, the partition grid is at least partially made of a ceramic material capable of withstanding a temperature greater than about 1500° C. The partition grid can comprise a plurality of apertures having a diameter smaller than about 0.1 cm.

In an embodiment, the pyrolysis system further comprises a plastic particle supply connected to the carbon-based feedstock inlet to supply the pyrolysis reaction chamber with plastic particles for pyrolysis.

In an embodiment, a volume of the pyrolysis reaction chamber is about between 80% and 95% of a total volume of the oxidation chamber and the pyrolysis reaction chamber.

In an embodiment, the pyrolysis system further comprises a condenser and a booster mounted downstream of the pyrolysis product outlet and in gas communication with the pyrolysis product outlet and the fuel inlet, the booster being configured to increase a gas pressure of a gaseous fuel before being directed to the fuel inlet.

In an embodiment, the pyrolysis reaction chamber contains a particle bed. The particle bed can comprise inert inorganic particles and/or thermo-catalytic particles selected from the group consisting of: dolomite or Ni—Al-spinel bearing particles.

According to still another general aspect, there is provided a pyrolysis process comprising: feeding an oxidation chamber of a pyrolysis reactor with an oxidizing agent and a fuel; at least partially oxidating the fuel in the oxidation chamber of the pyrolysis reactor to supply heat to a pyrolysis reaction chamber of the pyrolysis reactor; feeding the pyrolysis reaction chamber of the pyrolysis reactor with a carbon-based feedstock to pyrolyze the carbon-based feedstock using heat generated by the at least partial oxidation of the fuel; and withdrawing a pyrolysis product from the pyrolysis reaction chamber of the pyrolysis reactor; and recirculating at least a portion of the pyrolysis product as fuel being fed to the oxidation chamber.

In an embodiment, the pyrolysis process further comprises the pyrolysis product into a gas product and a liquid product and wherein the fuel comprises at least a portion of the gas product obtained from the separation of the pyrolysis product.

In an embodiment, the oxidation chamber is fed continuously with the oxidizing agent and the fuel and the pyrolysis reaction chamber is fed continuously with the carbon-based feedstock. The pyrolysis product can be withdrawn continuously from the pyrolysis reaction chamber.

In an embodiment, the oxidizing agent comprises at least one of air and oxygen.

In an embodiment, the carbon-based feedstock is a plastic-based feedstock and, more particularly, the plastic-based feedstock can be substantially chlorine-free. It can comprise plastic particles having a diameter smaller than about 1.5 cm and, in a particular embodiment, between about 0.1 cm and 1.3 cm.

In an embodiment, the pyrolysis of the carbon-based feedstock is carried out at a temperature ranging between about 550° C. and about 900° C. and, in a particular embodiment, at a temperature ranging between about 600° C. and about 850° C.

In an embodiment, the carbon-based feedstock has a mean residence time between about 5 seconds and about 10 seconds in a pyrolysis reaction chamber of the pyrolysis reactor.

In an embodiment, feeding the oxidation chamber with the oxidizing agent and the fuel and feeding the pyrolysis reaction chamber with the carbon-based feedstock is carried out continuously.

In an embodiment, withdrawing the pyrolysis product is carried out continuously.

In an embodiment, the pyrolysis process further comprises condensing at least a portion of the pyrolysis product withdrawn from the pyrolysis reaction chamber and increasing a pressure of a portion of the pyrolysis product following condensation and before recycling the at least a portion of the pyrolysis product as the fuel fed to the oxidation chamber.

In an embodiment, the fuel and the oxidation agent are fed into the oxidation chamber in a ratio ranging between about 0.5 and about 1.1 and, in a particular embodiment, in a ratio ranging between about 0.9 and about 1.1.

In an embodiment, the pyrolysis of the carbon-based feedstock is performed in a pyrolysis chamber of the pyrolysis reactor containing a fluidized particle bed. The fluidized particle bed can comprise inert inorganic particles and/or thermo-catalytic particles selected from the group consisting of: dolomite or Ni—Al-spinel bearing particles.

In an embodiment, the fuel fed to the oxidation chamber comprises at least one of hydrocarbons, carbon monoxide, and hydrogen.

In an embodiment, the pyrolysis product withdrawn from the pyrolysis reaction chamber at least one of light hydrocarbons, carbon dioxide, carbon monoxide, water, and hydrogen.

According to a further general aspect, there is provided a process for producing carbon nanofilaments. The process comprises: continuously feeding a pyrolysis reactor with a carbon-based feedstock; pyrolyzing the carbon-based feedstock to generate a pyrolysis product; withdrawing the pyrolysis product from the pyrolysis reactor; continuously feeding a carbon sequestration reactor with at least a portion of the pyrolysis product, the carbon sequestration reactor containing a carbon sequestration catalyst to form carbon nanofilaments; and withdrawing the carbon nanofilaments from the carbon sequestration reactor.

In an embodiment, the carbon nanofilaments are continuously withdrawn from the carbon sequestration reactor.

In an embodiment, the carbon-based feedstock is a plastic-based feedstock.

In an embodiment, withdrawing the pyrolysis product from the pyrolysis reactor comprises continuously withdrawing the pyrolysis product from the pyrolysis reactor.

In an embodiment, withdrawing the pyrolysis product from the pyrolysis reactor comprises continuously withdrawing a gaseous phase of the pyrolysis product from the pyrolysis reactor.

According to still a further general aspect, there is provided a carbon sequestration reactor for producing carbon nanofilaments comprising: a housing defining a reaction chamber with a tapered portion and containing catalyst particles, the housing having a gas inlet and a gas outlet defined therein, the gas inlet being opened in the tapered portion of the reaction chamber and the gas outlet being located in an outlet portion of the reaction chamber and above a bed of the catalyst particles; and a carbon sequestration unit located inside the reaction chamber and comprising: a first gas conduit mounted above the gas inlet and vertically spaced-apart therefrom, the first gas conduit being opened at both ends.

In an embodiment, the first gas conduit is co-axial with the gas inlet.

According to still a further general aspect, there is provided a process for producing carbon nanofilaments. The process comprises: feeding a reaction chamber containing carbon-sequestration catalyst particles with a continuous gaseous flow containing hydrocarbon compounds and carbon oxide through a gas inlet located in a tapered portion of the reaction chamber; and inside the reaction chamber, introducing at least partially the gaseous flow into a first gas conduit mounted above the gas inlet and vertically spaced-apart therefrom, the first gas conduit being opened at both ends; and withdrawing gas from the reaction chamber through a gas outlet located in an outlet portion of the reaction chamber and above a bed of the catalyst particles, whereby, during operation, the catalyst particles are siphoned up and fluidized by the gaseous flow and travel up to the first gas conduit through a space defined between the first gas conduit and the gas inlet and through the first end of the first gas conduit, exits at the top end of the first gas conduit, and fall outside the first gas conduit and towards the tapered portion of the reaction chamber to be recirculated.

In an embodiment, the process further comprises preventing the catalyst particles from flowing into the gas inlet.

In an embodiment, the carbon oxide comprises carbon dioxide.

In an embodiment, the gaseous mixture is fed to the reaction chamber through a funnel shaped portion.

In an embodiment, a gaseous mixture of the gaseous flow fed to the reaction chamber has a temperature above 400° C.

In an embodiment, a gaseous mixture of the gaseous flow contained inside the reaction chamber has a temperature between about 400° C. and about 600° C.

In an embodiment, the process further comprises filtering the gas withdrawn from the reaction chamber to recover carbon nanofilaments from the gas.

According to a general aspect, there is provided a pyrolysis system comprising: a pyrolysis reactor including: a housing defining a pyrolysis reaction chamber and an oxidation chamber separated from the pyrolysis reaction chamber through a partition grid and located below the pyrolysis reaction chamber, the housing having a carbon-based feedstock inlet opened in the pyrolysis reaction chamber, a pyrolysis product outlet opened in the pyrolysis reaction chamber, and a fuel inlet in gas communication with the oxidation chamber, wherein the pyrolysis product outlet is in fluid communication with the fuel inlet of the pyrolysis reactor to direct at least partially a pyrolysis product into the oxidation chamber of the pyrolysis reactor.

In an embodiment, the pyrolysis system further comprises a phase separation unit connected to the pyrolysis product outlet and separating the pyrolysis product into a gaseous fuel and a liquid product, wherein the pyrolysis product outlet is in fluid communication with the fuel inlet of the pyrolysis reactor at least via the phase separation unit to direct at least partially the gaseous fuel into the oxidation chamber of the pyrolysis reactor.

In an embodiment, the fuel inlet is in gas communication with a gaseous fuel supply and an oxidizing agent supply. The oxidizing agent supply can comprise at least one of an air supply and an oxygen supply. The pyrolysis system can further comprise a pyrolysis product recirculation conduit in fluid communication with the pyrolysis product outlet and the fuel inlet and a mixer mounted to the pyrolysis product recirculation conduit, upstream of the fuel inlet and downstream of the oxidizing agent supply and in gas communication therewith.

In an embodiment, the pyrolysis product recycled into the pyrolysis reactor is supplied to the oxidation chamber through the fuel inlet.

According to another general aspect, there is provided a pyrolysis process comprising: feeding an oxidation chamber of a pyrolysis reactor with an oxidizing agent and a fuel; at least partially oxidating the fuel in the oxidation chamber of the pyrolysis reactor to heat a pyrolysis reaction chamber of the pyrolysis reactor; feeding the pyrolysis reaction chamber of the pyrolysis reactor with a carbon-based feedstock to pyrolyze the carbon-based feedstock using heat generated by the at least partially oxidation the fuel; and withdrawing a pyrolysis product from the pyrolysis reaction chamber of the pyrolysis reactor; wherein the fuel fed to the oxidation chamber comprises at least a portion of the pyrolysis product.

In an embodiment, the pyrolysis system further comprises separating the pyrolysis product into a gas product and a liquid product and wherein the at least a portion of the pyrolysis product comprises at least a portion of the gas product obtained from the separation of the pyrolysis product.

In an embodiment, the pyrolysis system further comprises separating the pyrolysis product into a gas product and a liquid product and wherein the at least a portion of the pyrolysis product is at least a portion of the gas product obtained from the separation of the pyrolysis product.

In an embodiment, the oxidation chamber is fed continuously with the oxidizing agent and the fuel and the pyrolysis reaction chamber is fed continuously with the carbon-based feedstock. The pyrolysis product can be withdrawn continuously from the pyrolysis reaction chamber.

In an embodiment, the oxidizing agent comprises at least one of air and oxygen.

In an embodiment, the carbon-based feedstock is a plastic-based feedstock.

In this specification, the term “hydrocarbon compound” is intended to include hydrocarbons and oxygenated hydrocarbons, i.e. an organic molecule containing one or more oxygen molecule in addition to carbon and hydrogen.

### BRIEF DESCRIPTION OF THE DRAWINGS

FIG. 1 is a flow diagram of a pyrolysis system in accordance with an embodiment;

FIG. 2 is a sectional view of a pyrolysis reactor, contained in the pyrolysis system of FIG. 1, in accordance with an embodiment;

FIG. 3 is a perspective sectional view of the pyrolysis reactor shown in FIG. 2;

FIG. 4 is a flow diagram of a pyrolysis system in accordance with another embodiment, wherein the system is free of recirculation loop for a gaseous fuel generated during a pyrolysis process;

FIG. 5 is a flow diagram of a carbon nanofilament manufacturing system in accordance with an embodiment;

FIG. 6 is a schematic cross-sectional view of a carbon sequestration reactor in accordance with an embodiment for the carbon nanofilament manufacturing system shown in FIG. 1;

FIG. 7 is a perspective sectional view of the carbon nanofilament reactor shown in FIG. 6; and

FIG. 8 is a flow diagram of a waste plastic conversion system in accordance with an embodiment.

It will be noted that throughout the appended drawings, like features are identified by like reference numerals.

### DETAILED DESCRIPTION

Moreover, although the embodiments of a fluidized bed pyrolyzer, a pyrolysis system, a carbon sequestration reactor and system and corresponding parts thereof consist of certain geometrical configurations as explained and illustrated herein, not all of these components and geometries are essential and thus should not be taken in their restrictive sense. It is to be understood, as also apparent to a person skilled in the art, that other suitable components and cooperation thereinbetween, as well as other suitable geometrical configurations, may be used for the fluidized bed pyrolyzer, pyrolysis system, carbon sequestration reactor and system, as will be briefly explained herein and as can be easily inferred herefrom by a person skilled in the art. Moreover, it will be appreciated that positional descriptions such as “above”, “below”, “left”, “right” and the like should, unless otherwise indicated, be taken in the context of the figures and should not be considered limiting.

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

Moreover, it will be appreciated that positional descriptions such as “above”, “below”, “forward”, “rearward” “left”, “right” and the like should, unless otherwise indicated, be taken in the context of the figures and correspond to the position and orientation of the fluidized bed pyrolyzer and the carbon sequestration reactor in operation. Positional descriptions should not be considered limiting.

In the following description, the term “about” means within an acceptable error range for the particular value as determined by one of ordinary skill in the art, which will depend in part on how the value is measured or determined, i.e. the limitations of the measurement system. It is commonly accepted that a 10% precision measure is acceptable and encompasses the term “about”.

In accordance with an embodiment, there is provided a fluidized bed pyrolyzer which, in an embodiment is a bubbling fluidized bed pyrolyzer, which can be operated autothermally (also referred to as autothermal fluidized bed pyrolyzer (ATP)), wherein the pyrolysis reaction creates synthesis gas (or syngas, i.e. raw gas produced from hydrocarbon and comprises hydrogen (H₂) and carbon monoxide (CO) as primarily components and carbon dioxide (CO₂), methane (CH₄), etc. as remaining components) using only thermal energy produced by the reaction itself. The fluidized bed pyrolyzer is also referred to as a pyrolysis reactor and can be included in a pyrolysis system. Inside the fluidized bed pyrolyzer, partial oxidation of a fuel and the following thermolysis (or thermal decomposition) of a carbon-based (or carbonaceous) feedstock are carried out. As it will be described in more details below, the partial oxidation of the gaseous fuel generates thermal energy for the pyrolysis of the carbonaceous material.

The feedstock for the pyrolysis reactor can include carbon-based materials including but without being limitative plastic waste, wood, biomass, paper mill residues, and the like. It can also incudes a mixture of several carbon-based materials and other contaminants. In an embodiment, the feedstock includes any pyrolysable organic-matter containing material. In an embodiment, the carbonaceous feedstock for the pyrolysis reactor is substantially chlorine-free (except unavoidable contaminants). In an embodiment, the carbonaceous feedstock is supplied as particles smaller than about 1.5 cm and in another embodiment between about 0.1 cm and about 1.3 cm.

The pyrolysis reaction product is withdrawn from the pyrolysis reactor mostly in a gaseous state and includes several constituents which can be used as fuel, as feedstock for synthesis gas or hydrogen, and as feedstock to manufacture carbon nanofilaments and/or carbon black, as will be described in more details below.

In an embodiment, the fluidized bed pyrolyzer and the associated pyrolysis process are configured to operate continuously or semi-continuously (semi-batch). Thus, the carbonaceous feedstock and the fuel are supplied as streams and the pyrolysis product is withdrawn from the pyrolysis reactor. In an embodiment, the fuel is a gaseous fuel. In another embodiment, the pyrolysis product is withdrawn continuously from the pyrolysis reactor. In an embodiment, a gaseous phase of the pyrolysis product is withdrawn continuously from the pyrolysis reactor while a solid phase and/or a liquid phase is withdrawn intermittently, i.e. by batches.

There is also provided a carbon sequestration reactor to produce carbon nanofilaments (CNFs). The carbon sequestration reactor can be included in a carbon nanofilament manufacturing system wherein the intrants are at least partially and a portion of the products of the pyrolysis system, i.e. the carbon nanofilament manufacturing system is mounted downstream the pyrolysis system and is fed with the gaseous products thereof. In an embodiment, the carbon sequestration reactor and the associated carbon sequestration process are configured to operate continuously.

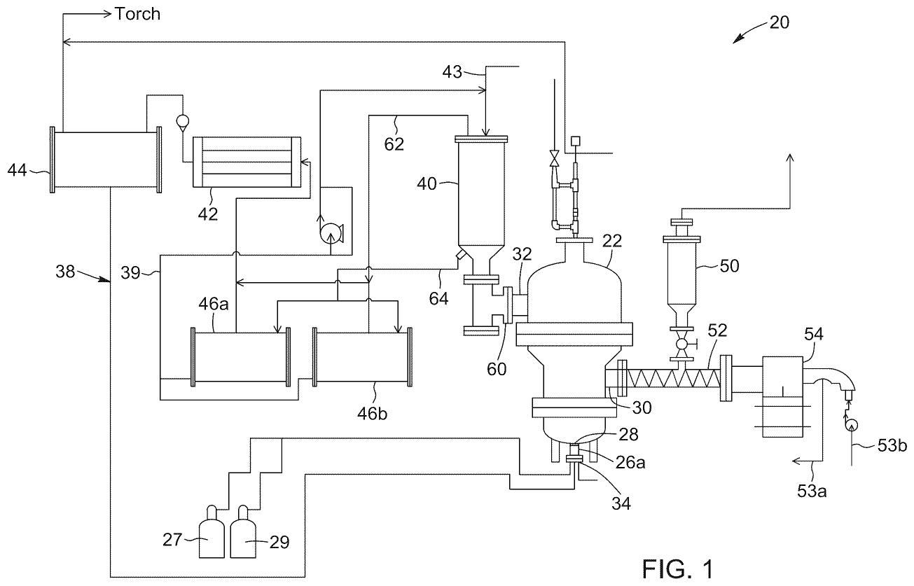

More particularly, referring to FIGS. 1 to 3, there is shown embodiments of a pyrolysis system 20 including a pyrolysis reactor 22 (also referred to as autothermal pyrolyser). The pyrolysis reactor 22 including a housing (or a reactor vessel) 24 defining an inner chamber 26 divided into two sub-chambers: an oxidation chamber 26a and a pyrolysis reaction (or thermolysis) chamber 26b. With respect to a gas flow, the oxidation chamber 26a is located downstream of the pyrolysis reaction chamber 26b. In a non-limitative embodiment, a volume of the pyrolysis reaction chamber is about between about 80% and about 95% of a total volume of the oxidation chamber and the pyrolysis reaction chamber.

In the embodiment shown in FIGS. 1 to 3, the oxidation chamber 26a and the pyrolysis reaction (or thermolysis) chamber 26b are in fluid communication but separated by a partition (or fluidisation) grid 28 (FIG. 1) allowing gases to flow through. In the embodiment shown, the oxidation chamber 26a is located below the pyrolysis reaction chamber 26b, i.e. it is located in the lower part of the housing 24.

The fluidized bed is located in the pyrolysis reaction chamber 26b, i.e. the oxidation chamber 26a is substantially free of fluidized bed particles. Thus, the partition grid 28, which divides the inner chamber 26 into the oxidation chamber 26a and the pyrolysis reaction (or thermolysis) chamber 26b, is designed to allow gases to flow through but prevent fluidized bed particles to flow into the oxidation chamber 26a.

In a non-limitative embodiment, the partition grid 28 is made of ceramic material(s) that can withstand temperatures of 1500° C. plus and is configuration is designed to allow a substantial oxidation of the gaseous fuel supplied to the oxidation chamber 26a. In a non-limitative embodiment, the partition grid 28 has a plurality of apertures extending through. The apertures have a diameter smaller than about 0.1 cm to allow gas to flow through but prevent plastic and fluidized bed particles to flow into the oxidation chamber 26a.

In the embodiment shown, the housing 24 has a carbon-based material inlet 30 opened in the pyrolysis reaction chamber 26b, a pyrolysis product outlet 32 opened in the pyrolysis reaction chamber 26b, and a fuel inlet 34 open in and in fluid communication with the oxidation chamber 26a. In the embodiment shown, air 27 and/or oxygen 29, acting as oxidizing agent in the oxidation reaction, and the fuel are mixed, for instance in a mixer, before being supplied to the pyrolysis reactor 22. Thus, in some embodiments, the pyrolysis system 20 includes a mixer located downstream of the fuel inlet 34. However, it is appreciated that, in an alternative embodiment (not shown), the housing 24 can include a fuel inlet in addition to the air 27 and/or oxygen 29 inlet, both being open in the oxidation chamber 26a.

In an embodiment, the fuel is in gaseous state when supplied to the oxidation chamber 26a, where the combustion is ignited. When the fuel is supplied in a gaseous state, the mixer, located upstream of the fuel inlet 34, can be a gas mixer.

Returning now to the non-limitative embodiment shown in FIG. 1, there is shown that the pyrolysis system 20 also includes a phase separation unit 40 connected to the pyrolysis product outlet 32 and separating the pyrolysis product 60 into a gaseous fuel 62 and a liquid product 64. More particularly, the pyrolysis products are in a gaseous state when exiting the pyrolysis reactor 22 through the pyrolysis product outlet 32. They are then directed to the phase separation unit 40 wherein they are partially condensed, and the liquid and gas products are at least partially separated from one another, i.e. the gaseous fuel 62 and the liquid product 64.

The phase separation unit 40 is in gas communication with the gaseous reactant inlet 34 (or fuel inlet 34) of the pyrolysis reactor 22, via fuel conduit(s) 38 (or pyrolysis product recirculation conduit), to recycle at least partially the gaseous fuel 62 into the oxidation chamber 26a of the pyrolysis reactor 22. Thus, the waste combustible gases exiting the pyrolysis reactor 22 are at least partially reintroduced into the lower section, i.e. the oxidation chamber 26a, of the pyrolysis reactor 22 to provide heat (or thermal energy), through their exothermic oxidation reactions, for the thermolysis of the carbonaceous feedstock that occurs in the upper section, i.e. pyrolysis reaction chamber 26b. The energy required for the feedstock pyrolysis is thus at least partially provided by oxidation of a portion of the pyrolysis product, within the same and a single pyrolysis reactor 22 (or any other pyrolysis reactor in fluid communication therewith and which is part of the pyrolysis system 20).

In an alternative embodiment, the pyrolysis system can be free of phase separation unit and the pyrolysis product 60, exiting the pyrolysis reactor 22, can be supplied, at least partially, to the oxidation chamber 26a of the pyrolysis reactor 22. The pyrolysis product 60 can be in a gaseous state or can include a liquid phase. The pyrolysis product outlet 32 can be in fluid communication with the fuel inlet 34 of the pyrolysis reactor 22, via a pyrolysis product recirculation conduit(s) 38, to recycle at least partially the fuel, in a gaseous state, contained in the pyrolysis product into the oxidation chamber 26a of the pyrolysis reactor 22.

In an embodiment, at least a portion of the non-condensable products (i.e. non-condensable components at room temperature) of the pyrolysis process are recycled as fuel for the oxidation reaction of the autothermal pyrolysis process. The non-condensable products can include light hydrocarbons such as CH₄, C₂H₆, and C₃H₈.

Thus, in the oxidation chamber 26a, a partial oxidation is performed. The partial oxidation is an exothermic reaction producing thermal energy, which can be used to perform the thermolysis (or thermal cracking) in the pyrolysis reaction chamber 26b, located above the oxidation chamber 26a, as summarized above.

Even if the partial oxidation supplies at least a portion of the thermal energy required for the feedstock thermolysis, the pyrolysis system 20 can include an outside energy supply (not shown). In an embodiment, the outside energy supplied is used at the beginning of the pyrolysis process until enough fuel is produced, recycled into the oxidation chamber 26a, and partially oxidized to generate thermal heat for the carbonaceous feedstock thermolysis. For instance and without being limitative, the outside energy supply can be used until the temperature inside the reactor 22 reaches about 700° C. to about 800° C. It can also be used once the pyrolysis reactor 22 has reached its operating regime in combination with or in replacement of the recycled fuel, obtained from the pyrolysis product.

In an embodiment, only a portion of the fuel generated by the pyrolysis reactor provides enough thermal energy for the carbonaceous material pyrolysis. However, as mentioned above, the fuel generated by the pyrolysis reactor can be combined with an external carburant supply, for instance to maintain a substantial constant carburant composition despite the variation in the composition of the carbon-based feedstock.

Thus, the pyrolysis reaction chamber 26b of the pyrolysis reactor 22 is fed with a carbonaceous feedstock, such as plastic waste. Pyrolysis occurs inside the pyrolysis reaction chamber 26b at a temperature ranging between about 550° C. and 900° C. and, in some embodiments, between about 600° C. and 850° C. The pyrolysis reaction chamber 26b contains a fluidized bed, which can be either be an inert inorganic particulate material, such as and without being limitative olivine or alumina or silica sand, or a component contributing as thermo-catalytic material, such as and without being limitative dolomite or Ni—Al-spinel bearing bed including particles smaller than about 500 μm and, in an embodiment, between about 100 μm and about 500 μm. It is appreciated that the inert inorganic particulate material can be pure or a mixture, e.g. a mining or metallurgical residue.

In an embodiment, the inner walls of the housing 24 defining the inner chamber 26 are lined with a ceramic-based coating.

Still referring to FIG. 1, a non-limitative embodiment of the pyrolysis system 20 will be described in further details. The pyrolysis system 20, or variations thereof, can be used to carry out a pyrolysis of a carbonaceous feedstock.

The carbonaceous feedstock is contained inside a feedstock reservoir 50 and fed to the pyrolysis reactor 22 via an endless screw conveyor 52. It is appreciated that the feeding system to supply carbonaceous feedstock to the pyrolysis reactor 22 can differ from the embodiment shown. The carbonaceous feedstock enters in the inner chamber 26 and, more particularly inside the pyrolysis reaction chamber 26b via the feedstock (organic material) inlet 30.

In the non-limitative embodiment shown, the endless screw conveyor 52 is actuated by a motor/gearbox assembly 54, cooled with water (water inlet 53a, water outlet 53b).

The pyrolysis reactor 22 is supplied with fuel, which can be a gaseous fuel, and oxidizing agent (air 27, oxygen 29, or a mixture thereof) in a lower portion thereof. More particularly, the fuel and oxidizing agent enter the oxidation chamber 26a via the fuel inlet 34. It is appreciated that each one of the fuel and the oxidizing agent can have its own inlet in the housing of the pyrolysis reactor. In some embodiments, the oxidizing agent (air 27 and/or oxygen 29) is supplied with the fuel in a stoichiometric ratio ranging between about 0.5 and about 1.1 and, in another embodiment, the stoichiometric ratio ranging between about 0.9 and about 1.1.

Thus, the pyrolysis reactor 22 is fed with a mixture of a fuel and the oxidizing agent (air 27 and/or oxygen 29) to carry out a partial oxidation reaction, which is exothermic, in the oxidation chamber 26a of the pyrolysis reactor 22 and generates thermal energy for another reaction, also carried out in the pyrolysis reactor 22, and more particularly, the pyrolysis reaction.

As mentioned above, in an embodiment, the pyrolysis system 20 includes a mixer, such as and without being limitative a gas mixer, located downstream of the fuel inlet 34. However, it is appreciated that, in an alternative embodiment (not shown), the housing 24 can include a fuel inlet in addition to the air and/or oxygen inlet.

As described above, the pyrolysis reactor 22 is also fed with an organic-based feedstock (or carbonaceous feedstock or carbon-based feedstock). The pyrolysis reaction, which occurs in the pyrolysis reaction chamber 26b of the pyrolysis reactor 22, is an endothermic reaction which requires the thermal energy from the partial oxidation reaction to occur. As mentioned above, pyrolysis occurs inside the pyrolysis reaction chamber 26b at a temperature ranging between about 600° C. and 900° C.

In the embodiment shown, the pyrolysis reactor 22 contains a bubbling fluidized bed. However, it is appreciated that it can contain a circulating fluidized bed.

In a non-limitative embodiment, the process carried out by the pyrolysis reactor 22 is a continuous process wherein the pyrolysis reactor 22 is continuously supplied with gaseous fuel, air and/or oxygen), and the carbon-based feedstock. In some embodiments, the mean residence time of the organic matter/carbonaceous material inside the pyrolysis reaction chamber 26b ranges between about 5 seconds to about 10 seconds.

The pyrolysis of the carbonaceous feedstock produces a pyrolysis product, which is withdrawn from the pyrolysis reactor 22 through the pyrolysis product outlet 32. The pyrolysis product outlet 32 has a port located in the pyrolysis reaction chamber 26b. The pyrolysis product can then be directed to a phase separation (condensation) unit 40 to produce a gaseous phase and a liquid phase, which are then separated into a gas product and a liquid product.

In the embodiment, the pyrolysis system 20 includes only one pyrolysis reactor 22. However, it is appreciated that it can include two or more pyrolysis reactors 22, which can be configured in a parallel configuration.

In the non-limitative embodiment shown, the phase separation (condensation) unit 40 is a counter-current scrubber (or spray tower) using water 43 as cooling liquid. Water can be recovered with the liquid product and separated from the other liquid constituents to be recycled into the pyrolysis system 20 and, more particularly, as cooling liquid of the phase separation (condensation) unit 40 via conduits 39.

As mentioned above, in an alternative embodiment (not shown), the pyrolysis system 20 is free of phase separation (condensation) unit 40 and at least a portion of the pyrolysis product can be directed, directly or indirectly, to the fuel inlet 34 of the pyrolysis reactor 22. In still an alternative embodiment (not shown), the pyrolysis system 20 can include a phase separation (condensation) unit 40 and a portion of the pyrolysis product can be directed to the phase separation (condensation) unit 40 and another portion of the pyrolysis product can be directed to the fuel inlet 34 of the pyrolysis reactor 22.

If the process is a continuous process, the pyrolysis product is withdrawn, optionally continuously withdrawn, from the pyrolysis reaction chamber 26b of the pyrolysis reactor 22 and directed to a phase separation (condensation) unit 40. In an embodiment, the carbonaceous feedstock can be supplied continuously to the pyrolysis reactor 22 while the pyrolysis product can be withdrawn discontinuously, as batches.

In the embodiment shown, the gaseous product (or gaseous phase), including the gaseous fuel, is directed to sequentially a condenser 42 and a booster 44 (or compressor) to increase the gas pressure before being recycled, at least partially, into the pyrolysis reactor 22, as described above.

In an embodiment, the gaseous product, which is a gaseous fuel, is at least partially returned to the pyrolysis reactor 22 and fed into the oxidation chamber 26a wherein partial oxidation occurs and generates thermal energy for the pyrolysis reaction, as described above. In an embodiment, the gaseous fuel fed to the oxidation chamber 26a can also include another fuel, which can be combined with at least a portion of the gas product obtained from the separation of the pyrolysis product.

The liquid phase of the pyrolysis product is recovered from the phase separation (condensation) unit 40 and directed to one or more settling tanks 46a, 46b. In the embodiment shown, the pyrolysis system 20 includes two settling tanks 46a, 46b configured in a parallel configuration but it is appreciated that the number and the configuration of the settling tanks, if any, can vary from the embodiment shown.

The gaseous products from the settling tanks 46a, 46b are directed to the condenser 42 while water contained in the liquid phase is recycled to the phase separation (condensation) unit 40.

In an embodiment, the liquid phase, excluding water, is recovered and its valuable content can be processed. For instance and without being limitative, a carbon sequestration process can be performed on the liquid phase to produce carbon nanofilaments (CNFs), as will be described in more details below.

In an alternative embodiment (not shown), the pyrolysis system can be free of phase separation (condensation) unit 40 and the pyrolysis product can be directed, at least partially, to the carbon sequestration process. For instance and without being limitative, the carbon sequestration process can be performed directly on the pyrolysis product following a gas/solid particles including ashes, as will be described in more details below. A portion of the product of the carbon sequestration process, including gaseous CO, can be return to the pyrolysis reactor 22 as feed for the oxidation chamber 26a.

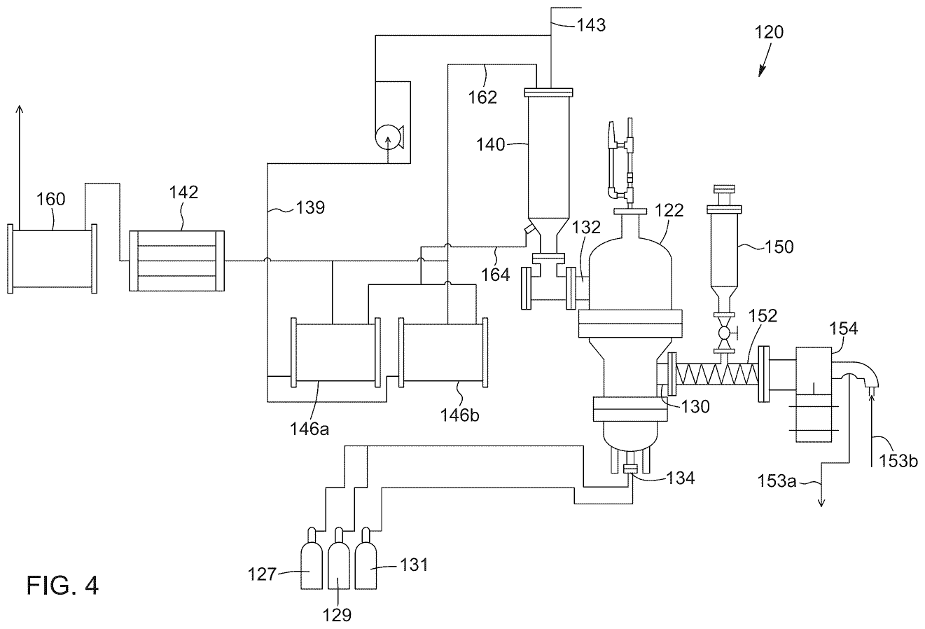

Turning now to FIG. 4, there is shown an alternative embodiment of the pyrolysis system 20 wherein the features are numbered with reference numerals in the 100 series which correspond to the reference numerals of the previous embodiment.

In the pyrolysis system 120, the components are substantially similar except that the pyrolysis reactor 122 is supplied with propane (C₃H₈) 131 as fuel instead of at least a portion of the products exiting the pyrolysis reactor 122. The pyrolysis product in liquid phase includes ethylene glycol, which is stored in a hydrocarbon reservoir 160, downstream the condenser 142.

It is appreciated that other suitable hydrocarbons can be used a fuel instead of propane and such hydrocarbons can also be used as outside energy supply in the system of FIG. 1.

At least a portion of the liquid pyrolysis product, mostly liquid hydrocarbons and oxygenated hydrocarbons, exiting the condensation unit 40, 140, or the settling tanks 46a, 46b, 146a, 146b, can be further processed. As used herein, the term “hydrocarbon compounds” includes hydrocarbons and oxygenated hydrocarbons. The hydrocarbon compounds supplied to the carbon sequestration reactor 270 can include saturated hydrocarbons, unsaturated hydrocarbons, oxygenated hydrocarbons, and mixtures thereof.

It is appreciated that features detailed above in reference to FIGS. 1 to 3 also apply to the embodiment shown in FIG. 4. Therefore, features of the embodiment shown in FIGS. 1 to 3 can be combined with features of the embodiment shown in FIG. 4 and vice-versa.

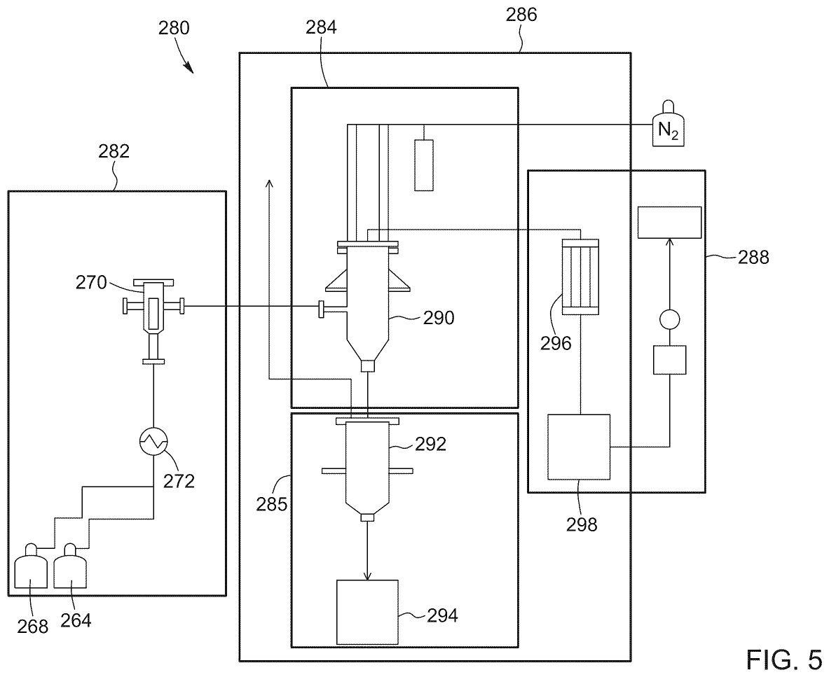

In FIG. 5, there is shown a non-limitative embodiment shown of a carbon nanofilament manufacturing system and process, which can be mounted downstream to the pyrolysis system of FIGS. 1 or 4, or alternative embodiments thereof.

In the embodiment of FIG. 5, the liquid product of the pyrolysis system 20, 120, which can be stored in a hydrocarbon compound tank 264, is transferred to the carbon nanofilament manufacturing system and, more particularly, fed into a carbon sequestration reactor 270 by a pump (not shown), such as and without being limitative a peristaltic pump. More particularly, in an embodiment, the pyrolysis reactor 22, 122 is fed with a plastic-based feedstock and the plastic-based feedstock is pyrolyzed to generate the pyrolysis product, which is withdrawn, optionally continuously withdrawn, from the pyrolysis reaction chamber 26b, 126b of the pyrolysis reactor 22, 122. At least a portion of the pyrolysis product including hydrocarbon compounds is fed to the carbon sequestration reactor 270, optionally continuously, in combination with carbon dioxide (CO₂), which can be contained and supplied from a CO₂ reservoir 268 (or any other suitable CO₂ supply).

The carbon sequestration reactor 270 contains a carbon sequestration catalyst (not shown) to form carbon nanofilaments (not shown), which can be withdrawn from the carbon sequestration reactor 270. In an embodiment, the carbon sequestration catalyst is iron-based and can include nickel. For instance, it can include an important concentration of iron or iron oxides (FeₓO_{y}), typically higher than about 50% mol. The quantity of the catalyst particles to be used is a function of the properties of the catalyst (including the particle size and their density) and the geometry of the reactor. This quantity is selected in a manner such that the hybrid operation (i.e. fluidized bed and moving bed) can be done appropriately. In an embodiment, the carbon sequestration catalyst includes particles smaller than about 500 μm and, in another embodiment, the catalyst particles have a diameter ranging between about 150 μm and about 500 μm.

As mentioned above, in an embodiment, the hydrocarbon compounds fed to the carbon sequestration reactor 270 can be a product of the autothermal pyrolyser 22, 122, as described above. They can be fed to the carbon sequestration reactor 270 substantially directly from the pyrolyser 22, 122 to the carbon sequestration reactor 270, without being scrubbed and cooled down to separate the liquid and solid phases. Thus, the heated carbon sequestration reactor 270 is fed with the output product of the pyrolysis reactor 22, 122, which is already hot and in gaseous state.

In an alternative embodiment, the carbon sequestration reactor 270 is fed solely with at least a portion of the liquid phase, produced by the condensation/scrubbing unit 40, 140 mounted downstream of the pyrolysis reactor 22, 122. Before being fed to the carbon sequestration reactor 270, the liquid hydrocarbon compounds are heated, in the preheating unit 272, to be converted into hydrocarbon compounds in gaseous state.

In another embodiment, the carbon sequestration reactor 270 can be fed with an alternative hydrocarbon compound supply (i.e. an hydrocarbon compound which is not a product of the pyrolysis reactor) in combination with carbon dioxide. In still a further embodiment, the carbon sequestration reactor 270 can be fed with a hydrocarbon compound mixture that is produced for several hydrocarbon compound supplies.

Inside the carbon sequestration reactor 270, the hydrocarbon compounds are dry reformed to produce carbon nanofilaments (CNFs), also referred to as carbon nanofibers, as will be described in more details below.

In the embodiment of FIG. 5, the carbon nanofilament manufacturing system 280 can be divided into a reaction portion 282 (including the carbon sequestration reactor 270) followed sequentially by a filtration portion 284, a CNF recovery portion 285, a bag filling portion 286, and a gas product dehumidification portion 288.

In the reaction portion 282, the gaseous mixture including the hydrocarbon compounds and the carbon dioxide (or carbon oxide) can be heated before being fed to the carbon sequestration reactor 270 in the preheating unit 272. In an embodiment, the hydrocarbon compounds are supplied in a liquid state to the preheating unit 272 and converted into their gaseous state therein. Furthermore, the gas mixture temperature is raised from ambient temperature to a temperature ranging between about 400° C. and about 600° C. In an embodiment, the carbon sequestration reactor 270 operates at a temperature ranging between about 400° C. and about 600° C.

It is appreciated that, if the hydrocarbon compounds are supplied in a gaseous state in a desired temperature range, the preheating unit 272 can be omitted.

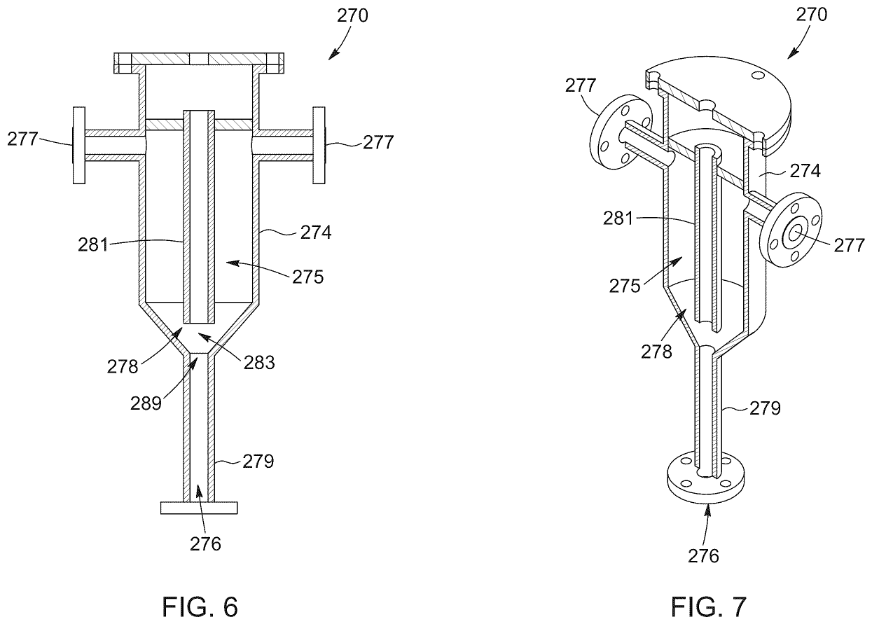

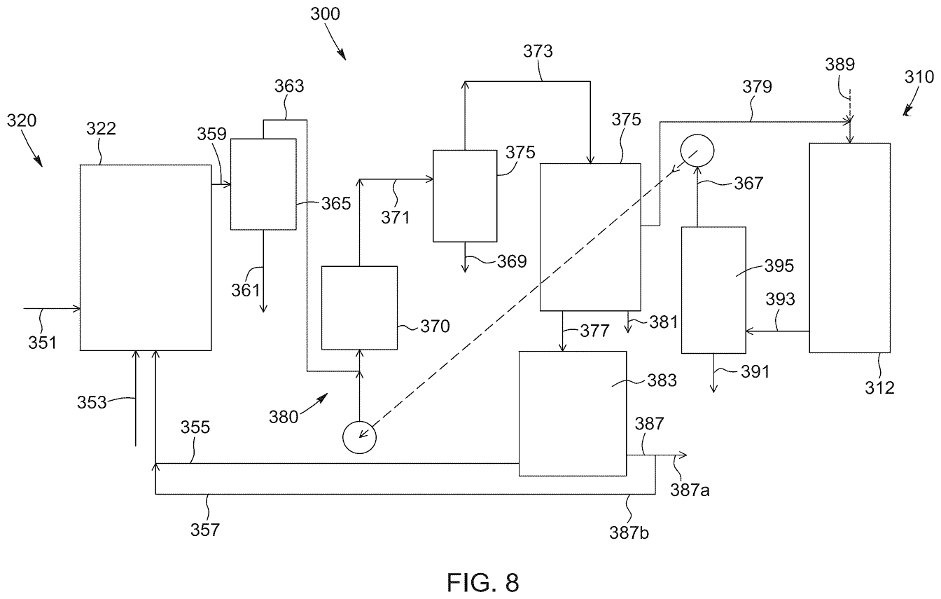

Then, the heated gas mixture is transferred to the carbon sequestration reactor 270. In a non-limitative embodiment and referring to FIGS. 6 and 7, the carbon sequestration reactor 270 comprises a housing 274 defining a reaction chamber 275 containing carbon sequestration catalyst particles (not shown). The housing 274 defines a tapered portion of the reaction chamber 275 with a gas inlet 276 defined therein and gas outlets 277 located in an outlet (upper) portion of the reaction chamber 275 and above a bed of the catalyst particles.

The bed of catalyst particles is a combination of a mobile bed and a fluidized bed. In a mobile bed, the particles, herein the catalyst particles, are constantly moving without being aerated; while in a fluidized bed, the catalyst particles, are kept fluidized by a flow of hot gas. The carbon sequestration reactor 270 combines the operation and the advantages of a central section fluidized catalyst particles bed with a slowly downwards moving catalyst bed in the annular section. Thus, in operation, the catalyst bed is homogenized, and its surface is being renewed continuously as the CNFs that form superficially eventually detach and are removed from the catalyst particle surface at the central fluidized part of the reactor. In the embodiment shown, unlike conventional reactors including moving beds, the carbon sequestration reactor 270 has no internal or external mobile mechanical parts.

A carbon sequestration unit 278 is located and contained inside the reaction chamber 275. The carbon sequestration unit 278 includes a first inner gas conduit 281 mounted above the gas inlet 276. In the non-limitative embodiment shown, the first inner gas conduit 281 is in the shape of a tubular member but it is appreciated that the shape thereof can vary from the embodiment shown. In the embodiment shown, the first inner gas conduit 281 is substantially co-axial with the gas conduit 279 of the gas inlet 276 and vertically spaced-apart therefrom, i.e. an inlet port of the first inner gas conduit 281 is spaced-apart from a port 289 of the gas conduit 279 of the gas inlet 276 opened in the reaction chamber 275. The inner gas conduit 281 divides a reactant gas flow entering into the reaction chamber 275 into a first gas flow portion flowing into an inner channel of the inner gas conduit 281 and a second gas portion flowing outwardly of the inner gas conduit 281, i.e. between an outer surface of the inner gas conduit 281 and an inner surface of the housing 274 delimitating the reaction chamber 275. Thus, the inner gas conduit 281 acts as a gas flow divider inside the reaction chamber 275.

In an alternative embodiment, the carbon sequestration unit 278 can include a second gas conduit (not shown), which extends in the reaction chamber 275 upwardly from the nadir of the tapered portion (or upwardly from port 289 of the gas conduit 279 of the gas inlet 276) and in continuity with the gas conduit 279 of the gas inlet 276 to prevent the catalyst particles from contacting or entering into the gas inlet 276. As the first inner gas conduit 281, the second gas conduit can also be a tubular member.

In the embodiment shown, to catalyst particles from contacting or entering into the gas conduit 279 of the gas inlet 276, the carbon sequestration reactor 270 can include a grid extending in the tapered portion of the reaction chamber 275 and covering the port 289 of the gas conduit 279 of the gas inlet 276 opened in the reaction chamber 275.

During operation of the carbon sequestration reactor 270, hot carbon oxide, such as CO₂, CO or a mixture thereof, will enter the reaction chamber 275 via the gas inlet 276 and flows up to first inner gas conduit 281. The catalyst particles, contained in the reaction chamber 275, are siphoned up and fluidized by the carbon oxide, thereby forming a fluidized bed in the reaction chamber 275. The fluidized catalyst particles travel up to the first inner gas conduit 281 through a space 283. The space 283 is defined between the first inner gas conduit 279 and the port 289 of the gas conduit 279 of the gas inlet 276 opened in the reaction chamber 275 (or from an outlet port of a second gas conduit extending upwardly in the reaction chamber 275 and connected to the gas conduit 279). The length of the space 283 is selected as a function of the properties of the catalyst (including the particle size and their density) and the geometry of the reactor. The length of the space 283 is selected in a manner such that the hybrid operation (i.e. fluidized bed and moving bed) can be done appropriately.

The catalyst particles exit at a top end of the first inner gas conduit 281 and fall outside the first inner gas conduit 281 and towards the tapered portion of the housing 274 to be eventually recirculated, thereby creating a constant recirculation of catalyst particles in reaction chamber 275. Gas exiting from gas outlets 277 will have had contact with catalyst particles going up and falling down around the first inner gas conduit 281. The size (length and diameter) of the elongated channel defined by the first inner gas conduit 281 is selected ensure appropriate contact time between the gas and the catalyst particles. In a non-limitative embodiment, the contact time is typically between about 1 and about 10 seconds and, in another embodiment, the contact time is between about 1 and about 5 seconds.

Some catalyst particles remain in the bottom of the reaction chamber 275 and serve a support material for the catalyst particles that form the fluidized bed, rather than directly participate to the carbon sequestration reaction.

In the non-limitative embodiment shown, the housing 274 includes two gas outlets 277 but it is appreciated that the number of gas outlets 277 can vary from the embodiment shown. The housing 274 can include one or more than one gas outlet. The position of the gas outlets 277 including their height from the bottom of the carbon sequestration reactor 270 is a function of various parameters. These parameters include: the total height of the first inner gas conduit 281 and the second gas conduit, if any, the vertical position of the spacing 283, the nature and total height of the bed of catalyst particles.

Inside the carbon sequestration reactor 270, CNFs are formed superficially on the catalyst particles and are freed by the gas draft and exit the carbon sequestration reactor 270 with the gas draft, through the gas outlet(s) 277.

In the non-limitative embodiment shown, the inner walls of the housing 274 in the tapered portion are shown as being substantially straight, angled towards the port 289 of the gas conduit 279 in gas communication with the reaction chamber 275. However, it is appreciated that, in an alternative embodiment (not shown), they can be curved or be of any other suitable shape. Furthermore, it is appreciated that the angle of the tapered portion of the reactor housing 274 (or the resulting reaction chamber 275) can vary in accordance with several process variables including and without being limitative the nature and properties of the catalyst particles contained in the reaction chamber 275, the nature of the process reagents, and the like.

Referring back to FIG. 5, there is shown that the products of the carbon sequestration reactor 270 are withdrawn and transferred to the filtration portion 284 of the carbon nanofilament manufacturing system 280. More particularly, the reactor products including a mixture of solids and gases are transferred to a filtering unit 290. In the non-limitative embodiment shown, the filtering unit is a metallic candle filter system, commercially available. In an embodiment, the metallic candle has very small pores to avoid CNF entrainment through their walls but most of the filtering is performed by a cake formed at these walls. As the cake thickness increases, the pressure drop increases. When the pressure drop becomes critically prohibiting, an inert gas pulsing technique is used to remove the cake and, then, recover the product at a reception vessel located at a bottom exit of the candle filter housing.

In a non-limitative embodiment, the reactor products can include, in addition to the CNFs, hydrocarbons such as C₂H₄, CH₄, and C₂H₆, carbon dioxide and monoxide, hydrogen, and water vapor.

The carbon nanofilaments are recovered in the lower portion of the filtering unit 290 and transferred to the CNF recovery portion 285 of the carbon nanofilament manufacturing system 280. From the filtering unit 290, the CNFs can be transferred to temporary storage tank 292 wherein excess gases (which can include hydrocarbons such as C₂H₄, CH₄, and C₂H₆, carbon dioxide and monoxide, hydrogen, and water vapor) are removed before transferring the solid CNFs to a CNF recovery tank 294 and are ready for further use. It is appreciated that the above-described embodiment of the filtration portion 284 of the carbon nanofilament manufacturing system 280 is a non-limitative embodiment and other embodiments can be foreseen.

The gaseous products of the filtering unit 290, which can include hydrocarbons such as C₂H₄, CH₄, and C₂H₆, carbon dioxide and monoxide, hydrogen, and water vapor, can be transferred in turn to the gas product dehumidification 288 of the carbon nanofilament manufacturing system 280. The gas product dehumidification 288 can include, sequentially, a condenser 296 followed by a liquid storage reservoir 298 (such as a glycol storage reservoir). Thus, in the gas product dehumidification stage 288, the gaseous products can be dehumidified in a liquid-gas contactor (or condenser 296), wherein the liquid phase can be glycol, and the dehumidified gas product can be sent to the pyrolyzing reactor to be burned and to provide at least a portion of the heat required for the endothermic pyrolysis reaction.

The above-described carbon nanofilament manufacturing system 280 is used to perform a carbon sequestration process, which products can be at least partially used as energy supply for the pyrolyzing reactor.

At the beginning of a carbon sequestration process, the carbon sequestration reactor 270 is preheated to a temperature ranging between about 400° C. and about 700° C. before being fed with CO₂ and the hydrocarbon compounds in gaseous state. In a non-limitative embodiment, the reactor 270 can be preheated electrically, via heated gas or via a heat exchanger. During this preheating stage, the reactor 270 contains the catalyst particles. In an embodiment, heated gas, such as and without being limitative, hydrogen, nitrogen, or a mixture thereof flows inside the reactor 272.

Following the preheating stage, the carbon sequestration process begins. As mentioned above, the carbon sequestration reactor 270 is fed, optionally continuously, with a mixture of hydrocarbon compound(s) and CO₂ in a gaseous state. If these gases are stored in pressurized reservoirs and exit these reservoirs at room temperature (about 25° C.), they are preheated to a temperature before being fed to the carbon sequestration reactor 270 to be dry reformed.

In an alternative embodiment, the carbon sequestration reactor 270 is fed with products from the pyrolyser 22, 122, without being scrubbed and cooled down to separate the liquid and solid phases inbetween. Thus, the heated carbon sequestration reactor 270 is fed with at least a portion of the output products of the pyrolysis reactor 22, 122, which are already hot and in gaseous state.

In still another embodiment, solely products from the pyrolyser 22, 122 in liquid phase are transferred to the carbon nanofilament manufacturing system 280. This feedstock in liquid phase is heated to be converted in a gaseous state before being fed to the carbon sequestration reactor 270 to be dry reformed.

In an embodiment, the mixture of hydrocarbon compound(s) and CO₂ in a gaseous state enters the carbon sequestration reactor 270 at a temperature ranging between about 400 and about 750° C. and, in another embodiment, between 550 and about 700° C.

In a non-limitative embodiment, the mixture including the hydrocarbon compounds and the carbon dioxide is fed to the carbon sequestration reactor 270 in a C/CO₂ molar ratio ranging from about 0.5 to about 2 and, in another embodiment, the C/CO₂ molar ratio ranging from about 0.8 to about 1.2.

In a non-limitative embodiment, the pressure drop across the fluidized bed of catalyst particles is between about 0.5 and about 4 atm and, in another embodiment, between 1 and about 2 atm.

The gas flows, including CNFs, outwardly of the carbon sequestration reactor 270 at a temperature ranging between about 500 and about 650° C. They are then directed to the filtering unit 290 of the filtration portion 284 of the carbon nanofilament manufacturing system 280. In a non-limitative embodiment, the reactor products can include, in addition to the CNFs, hydrocarbons such as C₂H₄, CH₄, and C₂H₆, carbon dioxide and monoxide, hydrogen, and water vapor.

The filtration unit 290 can also be fed with an inert gas, such as nitrogen.

The products of the filtration unit include the carbon nanofilaments and gas. The CNFs are recovered and transferred to a temporary storage tank 292 of the CNF recovery portion 285 of the carbon nanofilament manufacturing system 280, wherein excess gases (which can include hydrocarbons such as C₂H₄, CH₄, and C₂H₆, carbon dioxide and monoxide, hydrogen, and water vapor) are removed before transferring the solid CNFs to the CNF recovery tank 294.

In turn, the gaseous products of the filtering unit 290 are transferred to the gas product dehumidification 288 of the carbon nanofilament manufacturing system 280, wherein they are sequentially partially condensed to produce glycol, which can be stored in a liquid storage reservoir 298. The remaining gaseous phase, following the gas product dehumidification stage 288, can be returned to the pyrolyzing reactor to be burned and to provide at least a portion of the heat required for the endothermic pyrolysis reaction.

### Example for the Carbon Sequestration Process

The above-described carbon sequestration reactor 270 was used to produce CNFs using a mixture of C₂H₄ and CO₂ as feedstock with a catalyst Fe/Al₂O₃ (10 wt % of iron within the catalyst). Two tests were performed. The process parameters and test results are detailed in the tables below. For both tests, an activation step was carried out before introducing the reactants into the reactor 270.

During the carbon sequestration process, the catalyst particles were fluidized until they overflowed the inner cylinder of the reactor 270 and settled at the top of the bed, in the annular area. Then, the catalyst particles felt again into the lower part of the inner cylinder to be fluidized again. The flux of the catalyst particles, back to the fluidized bed, ensured continuity.

TABLE 1
Process parameters of the carbon sequestration process.

| | Test A | Test B |
|---|---|---|
| Activation conditions | | |
| Catalyst | Fe/Al₂O₃ (10 wt %) | Fe/Al₂O₃ (10 wt %) |
| H₂ flowrate (SLPM) | 1 | 2 |
| N₂ flowrate (SLPM) | 2 | 2 |
| Catalyst weight (kg) | 0.5 | 0.5 |
| Time on stream (TOS) (h) | 0.5 | 0.5 |
| Temperature (° C.) | 600 | 600 |
| Reaction conditions | | |
| Catalyst | Fe/Al₂O₃ (10 wt %) | Fe/Al₂O₃ (10 wt %) |
| C₂H₄ flowrate (SLPM) | 3 | 3 |
| CO₂ flowrate (SLPM) | 1 | 1 |
| Catalyst weight (kg) | 0.5 | 0.5 |
| Time on stream (TOS) (h) | 6 | 4 |
| Temperature (° C.) | 550 | 600 |

TABLE 2
General experimental results of the carbon sequestration process.

| | Test A | Test B |
|---|---|---|
| Carbon (g) | 615 | 291 |
| Carbon production rate | 0.21 | 0.15 |
| (kg_{C} · kg_{cat}⁻¹ · h⁻¹) | | |
| Carbon yield (%) | 53.19 | 37.3 |
| Hydrogen yield (%) | 46.38 | 43.1 |
| Total C₂H₄ conversion (%) | 73.04 | 48.5 |
| Total CO₂ conversion (%) | 69.87 | 57.2 |
| Mass balance error for C (%) | 6.28 | 7.6 |
| Mass balance error for H (%) | 4.01 | 5.3 |
| Mass balance error for O (%) | 9.62 | 4.9 |

Turning now to FIG. 8, there is shown a waste plastic conversion system that can be used to carry out a process to convert a carbon-based feedstock, such as waste plastics, into several valuable products including carbon nanofilaments and hydrogen. The system 300 includes three sub-systems, each one including its own reactor, namely a pyrolysis system 320 including the autothermal pyrolysis reactor 322, a carbon sequestration system 380 including a carbon sequestration reactor 370, and, optionally, a graphene and/or carbon black synthesis system 310 including a plasma reactor 312. The plasma reactor can be any suitable reactor such as and without being limitative the one disclosed in U.S. Pat. No. 5,997,837 to Lynum, which is incorporated herein by reference.

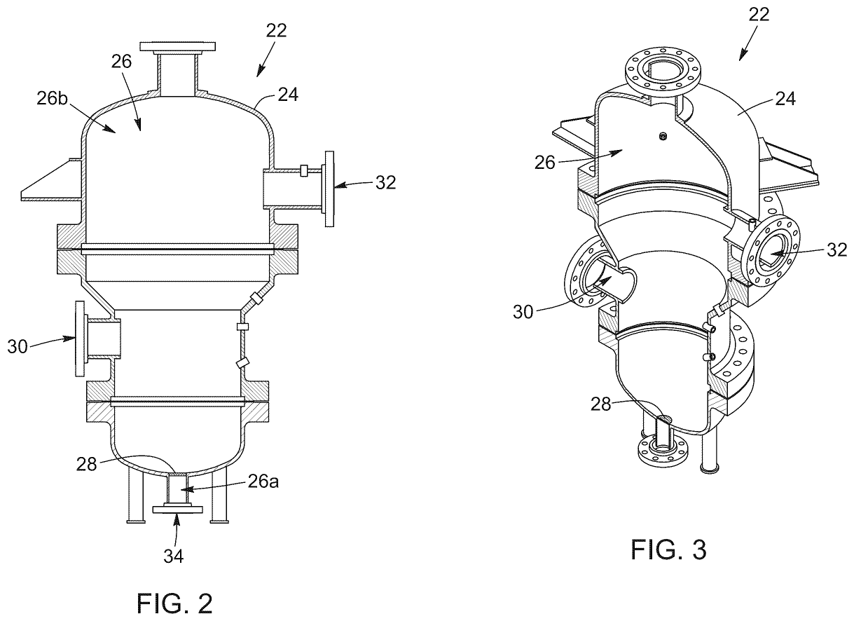

The pyrolysis system 320 shown in FIG. 8 has a few differences with the ones 20, 120 shown in FIGS. 1 and 4. However, it is appreciated that features of the pyrolysis system 320 can be replaced by those of the pyrolysis systems of FIGS. 1 and 4 (or alternatives thereof). Similarly, the pyrolysis system 320 of FIG. 8 can be operated without the carbon sequestration system 380 and/or the graphene and/or carbon black synthesis system 310, or only portions thereof. Furthermore, the pyrolysis reactor 322 can be the one shown in FIGS. 2 and 3, or have similar features therewith.

The carbon sequestration system 380 shown in FIG. 8 has a few differences with the one 280 shown in FIG. 5. However, it is appreciated that features of the carbon sequestration system 380 can be replaced by those of the carbon sequestration system of FIG. 5 (or alternatives thereof). Similarly, the carbon sequestration system 380 of FIG. 8 can be operated without the pyrolysis system 320 and/or the graphene and/or carbon black synthesis system 310, or only portions thereof. Furthermore, the carbon sequestration reactor 370 can be the one shown in FIGS. 6 and 7, or have similar features therewith.

In addition to graphene and/or carbon black, the products of the plasma reactor 312 include H₂, which is produced substantially without greenhouse gas (GHG) emissions from a gaseous feedstock including methane (CH₄).

The main product of the overall system 300 and the associated process includes H₂, CNFs, and graphene and/or carbon black.

Amongst others, the system can be used to synthesis H₂ substantially without greenhouse gas (GHG) emissions from a gaseous feedstock including methane (CH₄).

As explained above, the end-of-life plastic 351 destined for landfill is treated in the autothermal pyrolyser 322 (or autothermal pyrolysis reactor) of the pyrolysis system 320. The feedstock of the autothermal pyrolyser 322 also includes oxygen 353, carbon monoxide (CO) 355, and hydrogen 357 (all in gaseous state), in addition to waste plastics 351. As shown in FIG. 8, the carbon monoxide (CO) 355 and hydrogen 357 that feeds the autothermal pyrolyser 322 are produced by the carbon sequestration reactor 370 of the carbon sequestration system 380. The products 359 of the autothermal pyrolyser 322 includes a solid fraction (mainly ashes) and a gaseous fraction, including light hydrocarbons, carbon dioxide (CO₂), hydrogen, and water vapor. In a non-limitative embodiment, the solid fraction 361 of the products 359 of the autothermal pyrolyser 322 can be separated from the gaseous fraction 363 in a solid-gas separation unit 365, such as and without being limited to a cyclone separator.

A gaseous fraction 367 produced by the graphene and/or carbon black synthesis system 310, including the light hydrocarbons and hydrogen, leaving the plasma reactor 312 can also be fed to the carbon sequestration reactor 370 for the CNF synthesis. In addition to the CNFs (i.e. the solid fraction) 369, products 371 of the carbon sequestration reactor 370 comprises a gaseous fraction 373 including hydrogen, CO, CH₄, and water vapor.

The products 371 of the carbon sequestration reactor 370 are separated into the gaseous fraction 367 and the solid fraction 369 in a solid-gas separation unit 375, such as a filtration unit.

The gaseous fraction 373 is then transferred to a first separation stage 375 wherein the CO and hydrogen 377 are separated from the residual CH₄ 379 and water vapor 381. In a second separation stage 383, the CO 355 is separated from the hydrogen 387. The CO 355 and at least a portion 387a of the hydrogen 387 can be returned to the autothermal pyrolyser 322, wherein the CO acts as energy supply. In turn, the methane (CH₄) 379 is transferred to the plasma reactor 312, to be used as feedstock.

From a methane-based feedstock (including methane 379 originating from the carbon sequestration reactor 370 and supplemental methane 389, if any), the graphene/carbon black synthesis system 310 produces hydrogen and hydrocarbons as gaseous fraction 367 and carbon black or graphene as solid fraction 391. More particularly, the products 393 of the plasma reactor 312 are separated in a solid-gas separation unit 395, such as and without being limitative a filtration unit.

As mentioned above, the gaseous fraction 367 can be directed to the carbon sequestration reactor 370, as part of the feedstock. The solid fraction 391, including graphene and/or carbon black, is recovered for further usage.

In the embodiment shown in FIG. 8, the pyrolysis products are directed to the carbon sequestration reactor 370. However, in an alternative embodiment (not shown), a gaseous portion thereof can be recycled to the pyrolysis reactor 322 and, more particularly, as fuel for the oxidation chamber of the pyrolysis reactor 322. In a non-limitative embodiment, about less than 20 wt % of the pyrolysis reactor 322 can be recycled as fuel and the remaining portion can be directed to the carbon sequestration reactor 370. As mentioned above, an additional fuel supply can be introduced in the oxidation chamber of the pyrolysis reactor 322 to regulate the fuel composition, if required.

It is appreciated that alternative embodiments described above in reference to FIGS. 1 and 4 can apply to the embodiment shown in FIG. 8 and vice-versa.

The above-described system provides at least partial solutions to some of the problems faced by the petroleum industry. First, hydrogen, required during petroleum acid, and ammoniac production, is produced. Second, carbon black is produced. Third, waste plastics, even contaminated or thermosetting plastics, are processed to obtain valuable products. Graphene and/or carbon black and CNFs can be used in specialized applications or as higher-value replacement materials for conventional carbon black usually manufactured using petroleum.

Table 3 below shows an exemplary mass balance without addition of methane (CH₄) in the plasma reactor based on an injection of 1t/h of non-recyclable polymers. This process does not maximize hydrogen production, but favors the formation of carbon filaments. To increase hydrogen production, methane can be added at a rate of 0.5 t/h allows to significantly increase the production of carbon black or even graphene and to withdraw about two times more hydrogen, still produced without substantial greenhouse gas release, as shown in Table 4 below.

TABLE 3
Exemplary mass balance using the process based on FIG.
8 fed with 1 t/h of polymers and without CH₄ addition.

| | |
|---|---|
| Input | Output |

| | | | | | |
|---|---|---|---|---|---|
| Plastics | 1000 | kg/h | CNFs | 626 | kg/h |
| Oxygen | 371 | kg/h | Carbon black | 188 | kg/h |
| Methane | 0 | kg/h | Hydrogen | 89 | kg/h |
| Electricity | 816 | kWh | Ashes | 50 | kg/h |
| | | | Water | 418 | kg/h |

TABLE 4
Exemplary mass balance using the process based on FIG. 8 fed
with 0.5 t/h of polymers and with CH₄ addition (0.5 t/h).

| | |
|---|---|
| Input | Output |

| | | | | | |
|---|---|---|---|---|---|
| Plastics | 500 | kg/h | CNFs | 427 | kg/h |
| Oxygen | 186 | kg/h | Carbon black | 362 | kg/h |
| Methane | 500 | kg/h | Hydrogen | 170 | kg/h |
| Electricity | 2006 | kWh | Ashes | 25 | kg/h |
| | | | Water | 209 | kg/h |

### Example for a Combined Pyrolysis and Carbon Sequestration Process

In the above description, an embodiment is an example or implementation of the inventions. The various appearances of “one embodiment,” “an embodiment” or “some embodiments” do not necessarily all refer to the same embodiments. Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions. Furthermore, although various features of the invention may be described in the context of a single embodiment, the features may also be provided separately or in any suitable combination. Conversely, although the invention may be described herein in the context of separate embodiments for clarity, the invention may also be implemented in a single embodiment.

It is to be understood that the details set forth herein do not construe a limitation to an application of the invention. Furthermore, it is to be understood that the invention can be carried out or practiced in various ways and that the invention can be implemented in embodiments other than the ones outlined in the description above.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element. It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The descriptions, examples, methods and materials presented in the claims and the specification are not to be construed as limiting but rather as illustrative only. The present invention may be implemented in the testing or practice with methods and materials equivalent or similar to those described herein.

Meanings of technical and scientific terms used herein are to be commonly understood as by one of ordinary skill in the art to which the invention belongs, unless otherwise defined.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

Please replace the claims in the application with the following set of new claims:

1. A process for producing carbon nanofilaments, the process comprising:
feeding a reaction chamber containing carbon-sequestration catalyst particles with a continuous gaseous flow containing hydrocarbon compounds and carbon oxide through a gas inlet;
inside the reaction chamber, introducing at least partially the gaseous flow into a first gas conduit mounted above the gas inlet and vertically spaced-apart therefrom, the first gas conduit being opened at both ends; and
withdrawing gas from the reaction chamber through a gas outlet located above a bed of the catalyst particles contained in the reaction chamber;
whereby, during operation, the catalyst particles are siphoned up and fluidized by the gaseous flow and travel up to the first gas conduit through a space defined between the first gas conduit and the gas inlet and through the first end of the first gas conduit, exits at the top end of the first gas conduit, and fall outside the first gas conduit to be recirculated.

2. The process as claimed in claim 1, further comprising preventing the catalyst particles from flowing into the gas inlet.

3. The process as claimed in claim 1, wherein the carbon oxide comprises carbon dioxide and wherein a C/CO₂ in the continuous gas flow fed to the reaction chamber is between about 0.5 and 2.

4. (canceled)

5. (canceled)

6. The process as claimed in claim 1, wherein the gaseous mixture is fed to the reaction chamber through a tapered portion thereof having a funnel shape and the catalyst particles fall outside the first gas conduit and towards the tapered portion of the reaction chamber to be recirculated.

7. The process as claimed in claim 1, wherein a gaseous mixture of the gaseous flow fed to the reaction chamber has a temperature above 400° C. and a gaseous mixture of the gaseous flow contained inside the reaction chamber has a temperature between about 550° C. and about 700° C.

8. (canceled)

9. The process as claimed in claim 1, wherein the gas withdrawn from the reaction chamber comprises carbon nanofilaments, hydrocarbon compounds, and at least one of carbon monoxide, carbon dioxide, hydrogen, and water vapor.

10. The process as claimed in claim 9, further comprising filtering the gas withdrawn from the reaction chamber to recover the carbon nanofilaments from the gas and dehumidifying the filtered gas.

11. (canceled)

12. The process as claimed in claim 1, wherein the gas are withdrawn continuously from the reaction chamber.

13. The process as claimed in claim 1, wherein the catalyst particles are iron-based and comprises at least 50% mol. of iron and the iron-based catalyst particles further comprise nickel.

14. (canceled)

15. The process as claimed in claim 1, wherein the catalyst particles comprise Fe/Al₂O₃ including at least 10 wt % of iron within the catalyst particles.

16. The process as claimed in claim 1, wherein the catalyst particles are smaller than about 500 μm.

17. (canceled)

18. The process as claimed in claim 1, further comprising heating liquid hydrocarbon compounds to a gaseous state before feeding the reaction chamber with the continuous gaseous flow containing the hydrocarbon compounds.

19. The process as claimed in claim 1, wherein the gaseous flow has a mean contact time between about 1 second and about 10 seconds in the reaction chamber and wherein a pressure drop across the bed of the catalyst particles ranges between about 0.5 atm to about 4 atm.

20. (canceled)

21. Carbon nanofilaments produced by the process as claimed in claim 1.

22.-91. (canceled)

92. A carbon sequestration reactor for producing carbon nanofilaments comprising:
a housing defining a reaction chamber with a tapered portion and containing catalyst particles, the housing having a gas inlet and a gas outlet defined therein, the gas inlet being opened in the tapered portion of the reaction chamber and the gas outlet being located above a bed of the catalyst particles contained in the reaction chamber; and
a carbon sequestration unit located inside the reaction chamber and comprising a first gas conduit mounted above the gas inlet and vertically spaced-apart therefrom, the first gas conduit being opened at both ends.

93. The carbon sequestration reactor as claimed in claim 92, wherein the first gas conduit is co-axial with the gas inlet and the first gas conduit is in register with the gas inlet.

94. (canceled)

95. The carbon sequestration reactor as claimed in claim 92, further comprising a second gas conduit extending in the reaction chamber and having a first end mounted to the housing and circumscribing the gas inlet and a second end spaced-apart from a first end of the first gas conduit and co-axial therewith and wherein the first end of the first gas conduit and the second end of the second gas conduit are in register.

96. (canceled)

97. The carbon sequestration reactor as claimed in claim 92, further comprising a grid covering the gas inlet to prevent carbon-sequestration catalyst particles to flow outwardly of the reaction chamber through the gas inlet; and a carbon dioxide supply in fluid communication with the gas inlet.

98. The carbon sequestration reactor as claimed in claim 92, further comprising a bed of carbon-sequestration catalyst particles and wherein the catalyst particles are iron-based and comprises at least 50% mol. of iron.

99.-101. (canceled)

102. The carbon sequestration reactor as claimed in claim 92, wherein the catalyst particles are smaller than about 500 μm.

103-139. (canceled)
